(19) United States
(12) Patent Application Publication
(10) Pub. No.: US 2005/0119894 A1
(43) Pub. Date: Jun. 2, 2005

(54) System and process for feedback speech instruction

(76) Inventors: Ann R. Cutler, Carmel, IN (US); Robert B. Gregory, Lafayette, IN (US)

Correspondence Address: BAKER & DANIELS, 300 NORTH MERIDIAN STREET, SUITE 2700, INDIANAPOLIS, IN, 46204-1782, US

(21) Appl. No.: 10/968,873

(22) Filed: Oct. 19, 2004

Related U.S. Application Data
(60) Provisional application No. 60/512,822, filed on Oct. 20, 2003.

(51) Int. Cl. G10L 21/00; G10L 17/00

(52) U.S. Cl. 704/270; 704/246

(57) ABSTRACT

The present invention involves methods and systems for providing feedback speech instruction. The method involves collecting data corresponding to a plurality of parameters associated with verbal and non-verbal expression of a speaker and analyzing the data based on an ideal model. The method also includes generating a report or an instruction responsive to the report, and delivering the report or the instruction to the speaker. The plurality of parameters associated with verbal and non-verbal expression includes pitch, volume, pitch variation, volume variation, frequency of variation of pitch, frequency of volume, rhythm, tone, and speech cadence. The system includes a device for collecting speech data from a speaker, a module with software or firmware enabling analysis of the collected data as compared to an ideal speech model, and an output device for delivering a report and/or instruction to the speaker.

This application claims benefit of U.S. Provisional Patent Application No. 60/512,822 filed Oct. 20, 2003.

### BACKGROUND OF THE INVENTION

1. Field of the Invention

This invention relates to the art of speech analysis, in particular process for speech analysis and feedback instruction.

2. Description of the Related Art

Speech is series of sounds that have musical parameters imbedded. These musical aspects of delivered speech, often called paralinguistic enhancements, are associated coarsely in written text with punctuation. In speech delivery, however, much more information can be conveyed paralinguistically than is indicated by mere punctuation.

Methods and devices have been developed for monitoring, recording, displaying and analyzing speeches for various purposes. Methods of providing various types of feedback have also been disclosed.

U.S. Pat. No. 4,139,732 discloses an apparatus for speech analysis having a pair of electrodes applied externally to the larynx region of the speaker's neck to detect the larynx waveform, which provides a basis both for the representation of intonation in speech and for the analysis of the frequencies defining other speech pattern features.

U.S. Pat. No. 4,276,445 discloses a device for converting sound information into an electrical signal and a user feedback visual display in real time. The only information extracted from the sound pattern is pitch frequency.

U.S. Pat. No. 5,566,291 discloses a user feedback interface for personal computer systems. The feedback viewing interface receives feedback data from one or more users and presents the feedback data to a reviewer according to specific preferences of the reviewer in forms capable of promoting improvement in systems incorporating these roles.

U.S. Pat. No. 5,884,263 discloses a method to integrate the speech analysis and documentation used in clinics and schools in a single automated proceeding. The method involves a note facility to document the progress of a student in producing human speech. A set of speech samples is stored and attached to selected sets of notes, thus, the teacher can navigate through the note file, review and provide opinion.

U.S. Pat. No. 6,417,435 discloses an audio acoustic proficiency test method for analyzing and reporting on the performance of a performer producing orderly sound sequence (pitch and rhythm). The method also issues proficiency performance certificates.

The methods and systems disclosed in the above cited references can only be used for specific applications and do not provide for a real-time feedback and instruction for public speakers.

### SUMMARY OF THE INVENTION

The present invention provides methods and systems for providing feedback instructions for speech improvement, based on an “ideal model” pattern.

In developing algorithms for a device of the present invention, any of several approaches may be used. Such algorithms include the following methods: a single sample of expert speech as a direct comparison, the collective profiling of a set of exemplary speech samples, and the extraction of speech parameters from sets of exemplary speech samples. The subsequent aspect in the process involves comparison of a user's speech against these parameters or samples. The user is then directed to alter his or her speech patterns to more closely approach exemplary speech as previously determined.

The development of an algorithm may involve the collection of samples encompassing a range of speech quality, the determination of exemplary or non-exemplary speech among these samples as judged by an expert panel, and extraction of parameters of speech performance by detailed voice analysis. Those parameters that varied strongly and consistently between exemplary and non-exemplary speech samples may be readily extracted by mathematical analysis. A weighting scheme may be determined objectively by finding those parameters that vary most strongly between speech samples, those that correlate more weakly, and weighting these parameters in the training profile accordingly. These weighted parameters extracted from a range of speech samples may then be used to train novices and non-exemplary speakers toward improved speech patterns in accord with the description of the invention. A permanent recording for later perusal may also be made at this time.

In one embodiment, the method for providing feedback instructions comprises the steps of: collecting data corresponding to a plurality of parameters associated with verbal and non-verbal expressions of a speaker; determining deviations of the collected data from a database of an ideal speech model; and instructing the speaker based on the deviations.

In one specific embodiment, the method further includes the step of developing the database of an ideal speech model, which may in turn include collecting ideal speech data corresponding to a plurality of parameters associated with verbal and non-verbal expressions of at least one ideal speaker; processing the collected ideal speech data by applying one or more pre-determined algorithm; and storing the processed ideal speech data in a database.

In another specific embodiment, after the speech data from a speaker are collected, it may be processed by applying one or more pre-determined algorithm; and then compared with the processed ideal speech data. A report based on the comparison may be subsequently generated, and delivered to one or more recipients, including the speaker.

In one form of the method, the report may include an instruction responsive to the result of the comparison. The instruction may include a verbal instruction, a non-verbal instruction, or a perceptible signal or a combination thereof. The perceptible signal may be an audio signal, a visual signal, a sign, or a tactile signal. The instruction may be delivered to the speaker by displaying on a display screen, or through an audio device, a visual device, or a tactile device.

In another form of the invention, the plurality of parameters associated with verbal and non-verbal expressions comprises one or more of: pitch, volume, pitch variation, volume variation, frequency of variation of pitch, frequency of volume, frequency of variation in volume, rhythm, tone, speech cadence, frequency of variation of speech cadence, and the cadence of the introduction of new topics and/or introduction of parenthetical topics as extracted by the above and other parameters.

In another embodiment of the invention, a method for developing a database of an ideal speech model comprises the steps of collecting ideal speech data corresponding to a plurality of parameters associated with verbal and non-verbal expressions of at least one ideal speaker; wherein the plurality of parameters comprises one or more of: pitch, volume, pitch variation, volume variation, frequency of variation of pitch, frequency of volume, rhythm, tone and speech cadence; and processing the collected ideal speech data by applying corresponding pre-determined algorithm to create an ideal speech model. The processed ideal speech data corresponding to the ideal speech model may be stored in a retrievable database.

In yet another embodiment, a system for providing feedback speech instructions comprises a device for collecting data corresponding to a plurality of parameters associated with verbal and non-verbal expressions of a speaker; a processor for analyzing the data based on an ideal speech model and generating a report, and an output device for delivering the report to at least one recipient. The device for collecting data may include a recorder, a sensor, a video camera, or a data entry device, and the output device may include an audio device, a visual device, a print device, a tactile device or a combination thereof.

In one specific embodiment, the system of the present invention includes a data entry device for entering an instruction responsive to the report; and an instruction delivery device for delivering the instruction to the speaker, which may be an audio device, a visual device, a tactile device, or a combination thereof.

It is an object of the present invention to provide methods and systems for improving speech delivery skills and persuasional or interpersonal impact of a public speaker or persuasional conversationalist.

It is another object of the present invention to provide methods and systems for use in speech therapy.

It is yet another object of the present invention to provide a device for monitoring and providing feedback to a speaker in real time.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 is a flow diagram of the method according to one embodiment of the present invention;

FIG. 2 is a flow diagram of the method according to another embodiment of the present invention; and

FIG. 3 is a block diagram of a system according to one embodiment of the present invention.

FIGS. 4 through 10 are voice pattern graphs.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE INVENTION

The present invention provides methods and systems for improving oral communication, either in the form of verbal or non-verbal expression or both. Although the emphasis is in the improvement of English oral presentation of a speaker, the methods and systems of the present inventions may be applicable to the oral presentation in any language.

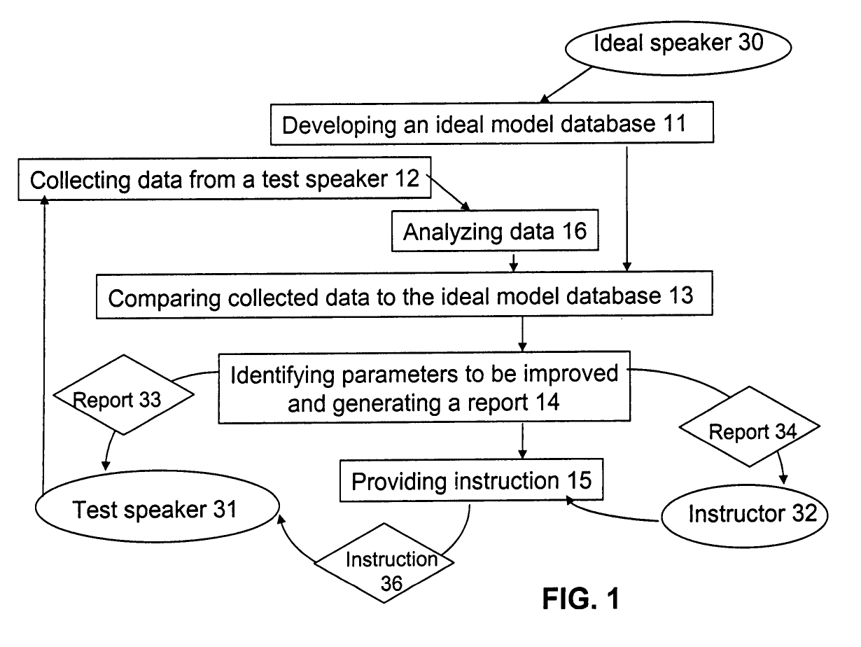

Referring now to FIG. 1, a flow diagram showing the steps in method 10 of the present invention is provided. In developing method 10, the inventor recognized that different speech acts require different verbal and non-verbal expressions. For example, to persuade a six year old does not require the same intonational parameters as to address a boss concerning a potential raise. Similarly, the invention is implemented on the theory that the effective persuasional or informative speech acts are advantageously measured against similar, but somewhat different models. Method 10 generally includes the step of developing an ideal speech model 11, which may be specific for certain speech act. Method 10 also includes the steps of collecting data from a speaker 12, comparing a test speech with the ideal model 13, identifying parameters for improvement 14, and providing feedback instructions 15.

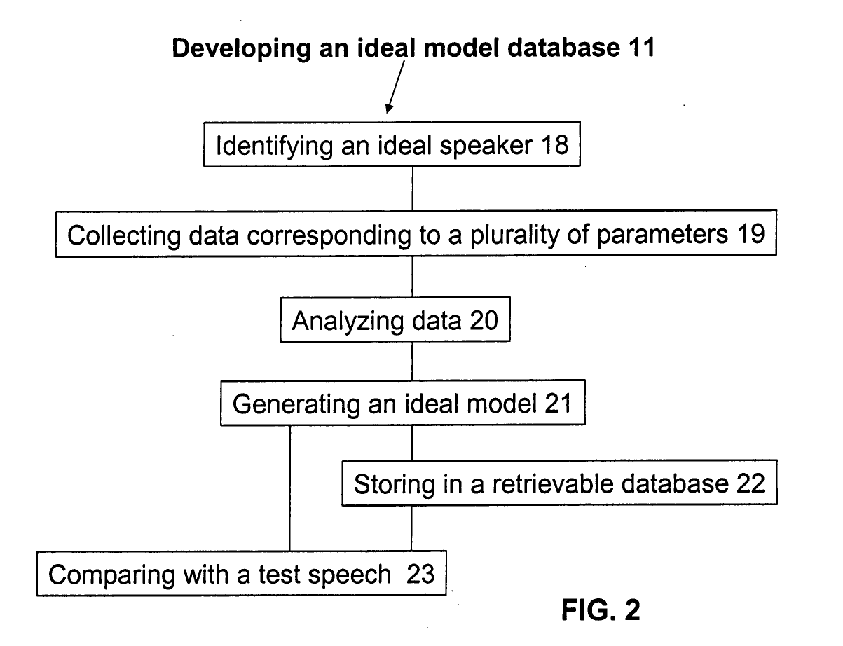

As demonstrated in FIGS. 1 and 2, developing the ideal model database 11 involves the steps of identifying an ideal speaker or speakers 18 (see FIG. 2). The speaker whose speech may be used as ideal model 30 (FIG. 1) may be selected in various ways. For example, in the case of a law school lecturer, discussion with students will readily yield names of the best and most effective lecturers. In the case of training a car salesperson training, recording the interactions of several highly successful car salespersons will similarly yield important data for that field. For comparative purposes, the efforts of several poor performers may also be useful in the database development.

An ideal speaker 30 may also be chosen based on desirable characteristics, generally known in the art. For example, effective speakers vary pitch (high or low note), volume (intensity) and cadence (spacing of sounds in time) to maintain the attention of an audience. Poor presenters do not vary these parameters, or vary them insufficiently to maintain attention. Listeners tend to become distracted or somnolent. Other obvious issues in the speech of poor presenters include shrillness (discordant harmonics), insufficient loudness (low volume), high average pitch range (which reduces credibility), and nasal voice (harmonic issues).

Once the speaker(s) for the ideal model is identified, the next step 19 (see FIG. 2) is to collect data corresponding to a plurality of parameters associated with a verbal and non-verbal expressions from the ideal speaker 30. In this step, speaker 30 is asked to make a presentation in a specified situation. The presentation may involve lecturing for education, presenting a written text by reading aloud, speaking extemporaneously, or presenting an emotionally charged narrative or engaging in a persuasive or motivational conversation, singing, acting or performing on a musical instrument. The presentation may be recorded using a recording device or devices such as a voice recorder, a video recorder, or any other device capable of capturing presentation information, such as an audio frequency sensor or vibration sensor.

As shown in FIG. 2, the next step 20 involves analyzing the collected data. In this step, the presentation information captured is transferred to a device capable of analyzing the presentation information. The device may include a computerized voice-analyzer, which includes a processor capable of breaking down the presentation information into measurable parameters which may include pitch, volume, pitch variation, volume variation, frequency of variation of pitch, frequency of volume, and speech cadence singly or in combination. Alternatively, the device may have software capable of concerting speech into text. In addition, the device may include a general purpose computer having software capable of performing calculations on the presentation data.

The parameters may be transformed into mathematical values representing an ideal model in step 21. The information related to the ideal model may be stored in a database in step 22 or used in comparison with other speeches or presentations in step 23. As the invention uses statistical methods, greater numbers of samples, both positive and negative controls, will enhance the accuracy of the value calculation and the subsequent output.

In developing the ideal model for a certain type of speech, it is possible to modify the mathematical values of certain parameters of the goal; or ideal speech pattern to enhance desirable characteristics or to mask the undesirable characteristics. Certain desirable and undesirable characteristics of specific parameters are presented in the following examples.

A rising pitch profile followed by a pause indicates either a question or a solicitation of ‘back channels’. Back channels refer to non-meaning-additive responses of the listener indicating understanding and/or attention. For example, in delivering a declarative sentence “I thought you were going out tonight.” but speak in a manner that rises at the end, I am clearly asking for further information. Use of the rising pitch profile within an extensive declarative narrative is a request for back channels. Frequently, just a “uh huh”, or “I see” that shows you understand the ongoing narrative is sufficient. Excessive use of this pattern is inherently distracting.

There is also a growing body of literature describing ‘floor keeping strategies’ in educational or formal lectures. These patterns of prosody are sometimes quite different than those used in conversational speech. For example, some lecturers pause mid sentence, then ‘rush through’ the remainder of the concept. This is a means of varying cadence and thereby maintaining audience attention. When used excessively, it appears as an affectation. Lecturers also sometimes produce extremely long sentences linking previously introduced concepts. The individual concept groups may be extracted by pitch and volume associated with the nouns emphasized by the lecturer as important. Again, excessive use of this ‘floor keeping’ technique is highly counterproductive.

Information considered parenthetical to the discourse by the speaker is typically presented with lower volume and rising pitch and volume profile. Excessive parenthetical information provided in a formal lecture may be counterproductive, but some is likely to enhance the flow and efficacy of the lecture. The presentation of information assumed to be already accessible to the audience is presented with lower pitch and lower volume.

Additionally, nouns presented in the typical pattern associated with assumed parenthetical information may be tabulated by using a combination of voice recognition software and parametric analyses of concurrent speaker prosody. Most interestingly, linguists note that nouns presented in a prosodic manner which demonstrates that the speaker assumes them to be already accessible to the listener gives considerable clues to the cultural assumptions made by the speaker about the audience. A tabulation of nouns so presented could yield information concerning cultural assumptions of the speaker.

Further, numeric counts of “um's”, “ah's”, “you know's”, or other potentially distracting sounds may be recorded, tabulated, and instruction forwarded to the speaker to aid in extinguishing excessive use of these distracters.

Moreover, it is possible that the ideal model may not be derived from a real speaker, but from a synthesized model based on pre-determined sets of training parameters specific for certain aspects of speech. These parameters may be identified by a voice coach or a speech therapist or other expert. The mathematical values for each of the parameters may be assigned or calculated. The calculations used in the algorithm may be made using any generally known formula for specific parameters. Similar considerations as described above for modification of the ideal model are equally applicable when a synthesized model is used.

As for specific algorithms, there are a large number of possibilities. In general terms, an algorithm is a mathematical combination of one or more parameters that is used to perform a function or reach a conclusion when it is applied to an input data set. Most definitions require the algorithm to be applied a finite number of times to a particular datum. In the present invention, the input data set is the subject's speech.

The algorithms entail combining one or more of the parameters that are measurable aspects of speech in a fixed set, which in object programming terms would be called a method. An example includes measuring the pitch variation of a section of speech. The number of variations of more than ⅓ of an octave in, i.e., a five minute period may be counted. This might be a measure of “perceived interest” on the part of the listener. The larger the number of variations encountered, the larger the value of the output of the processor would be, and, thus, the higher the “signal” that the speaker or the analyst would see on the output device would be.

Another algorithm might be to use the speech recognition software to parse the speech stream into sentences. Then, the average, maximum, and minimum pitches in that sentence are determined. Then the time periods corresponding to the last third of each sentence are analyzed to look for the delivery of important conclusions or introduction of new concepts by looking for pitch inflection of a particular amount and direction from the average pitch of the sentence.

An even more complex algorithm would be to analyze the speech stream for a combination of rising pitch and increasing cadence as an indication of speaker energy. Too much energy could cause angst in listeners. Too little will cause them to fall asleep. This would require parsing the speech using the speech recognition output, and taking the output as a means of measuring cadence. Analyzing the stream for pulsations caused by breathing and the syllables uttered in the speech is another cadence and pacing measure which is somewhat distinct from measuring the word frequency in the speech. So this parameter would also be included. As the speaker continues to speed up in cadence, the ability to form sentences clearly becomes more difficult, and undesirable breaks occur, often with the inclusion of extra utterances, such as “um, . . . ” and “uh, . . . ” Counting those adds to the output value, according to some weighting function. The speaker's task would be to keep the value of the output within some limits for most of the time they are speaking, reserving high energy output for the climax of the concept being presented.

Furthermore, shrillness may be measured by determining the formants of the speech and measuring the spread between the first, second, third, and fourth formants. Additionally, the intensities of the first, second, third, and fourth harmonics in the speech itself is another measure of shrillness. To examplify the development of a suitable algorithm in accordance with the present invention, an example of such a development process is illustrated below.

In the first step, sufficient speech samples are recorded to cover the range of speech necessary to discriminate between effective and non-effective speech. In this example, one collects the speech of faculty and students of a sufficiently wide range of experience that all levels of speech effectiveness are covered, irrespective of content. This forms the master database of speech required to establish the training algorithms. In order to set proper parameter levels, the speech data need not be rank ordered. An independent panel of experts may be utilized to evaluate the efficacy of the speech samples in the database. The speech may then be analyzed for a variety of potentially significant prosodic properties, and these values compared to the rank assigned by the expert panel. Variables that correlate strongly with an assessment of expert speech performance then become aspects of the feedback given to the user.

The data analysis of speech samples may be performed in a number of ways. It may be analyzed in the time domain, as in the cases of pitch, the change in pitch, or cadence. Alternatively a bulk analysis may be performed on a dataset representing the entire speech sample. The pitch of the speech versus formant frequencies represents one such analysis. These are to be considered examples of possible analyses, and do not represent an inclusive set. From such studies, a basis set of parameters that correlate with speaker efficacy is extracted. This basis set forms the initial measurement space to be used in real time analysis.

The next step adapts the parameters in the basis set to the sequential nature of real-time speech analysis. For some parameters, this adaptation is straightforward. Parameters such as the rate of change in pitch or the pacing of speech are innately temporal. The process of adapting these parameters usually involves creating a time-sampling window for the data. The width of the window (the data collection time length) is set so that changes measured do not occur on such a short time scale as to contain significant spurious content, or on such a long time scale that meaningful information is obscured. For example, a window may be set to accept one second of data samples taken every 0.01 seconds. In that window, the analysis of the change in pitch may be considered to be pseudo-real-time. The window may then be shifted a fraction of the window width, or an entire window width down the data stream for the next analysis frame.

For other parameters, such as the correlation between pitch and formant frequencies, a sliding window may be used to bundle an appropriate quantity of time-related data for processing as a pseudo-bulk analysis. This process results in a moving-average analysis of these parameters. The speed of this type of comparison measurement provides updates to the user on a frequency that is sufficiently high that the user perceives it as a real-time, or near-real-time analysis.

As an example of an implementation of the algorithm, speech samples were collected from a series of experienced speakers (university science faculty) and novice speakers (students drawn from a required public speaking course at a university) for the test database. The speech samples were parsed into two random five-minute samples per speaker. The only criteria for selection of a segment of speech was that it contain only the speaker's voice, and that it contain a minimum of paused spaces longer than approximately five seconds. This eliminated any chance of analyzing non-speech sounds or noise in the room.

The samples were judged for speech efficacy by a panel of expert reviewers, none of whom were part of the speech database. This panel was comprised of three full-time university professors, each of whom teaches public speaking, communications, and/or rhetoric in the speech and communications department of a respected private university. These reviewers were asked to rate, on a scale of 1 to ten, the ability of the speaker to hold the attention of the listener, independent of content. A score of 1 was considered to be no ability to hold listener attention, while a score of 10 was considered expert delivery.

The results of these evaluations were tabulated and used to create a stacked ranking of the sampled speakers. This ranking then guided an exploration of the bulk voice parameters found in the speakers' data. In this example, the analysis was performed using a voice-signal analysis program named Praat, one of the principal analysis programs used in this area. Pratt is authored by Paul Boersma and David Weenink of the University of Amsterdam (Herengracht 338; 1016CG Amsterdam; The Netherlands) and which is available from the web site http://www.fon.hum.uva.nl/praat/. Other voice-signal analysis programs may also be used. Although all speech samples were ranked by the expert panel, only the experienced speakers were used as data set members for purposes of this example. These speakers ranked from highly effective, to less than ideally effective in maintaining the attention of an average listener.

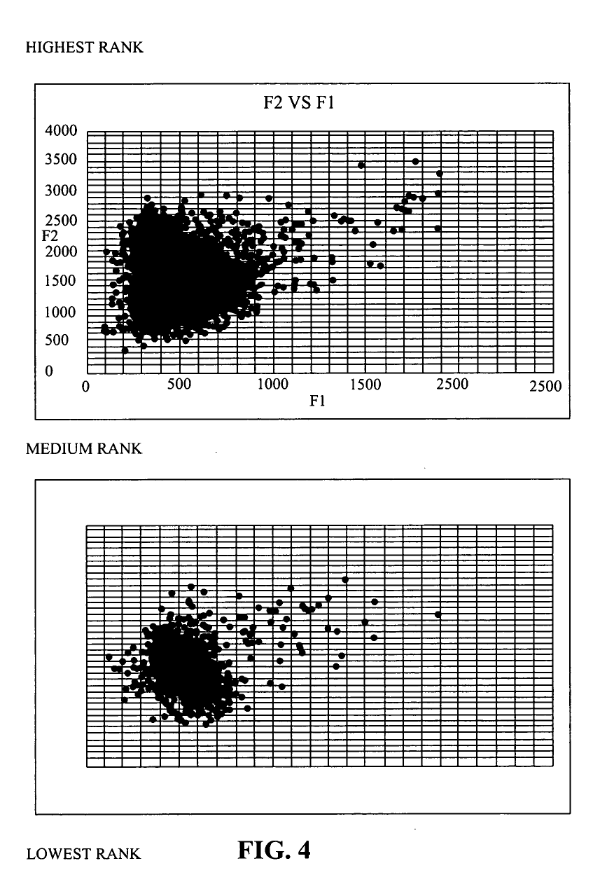

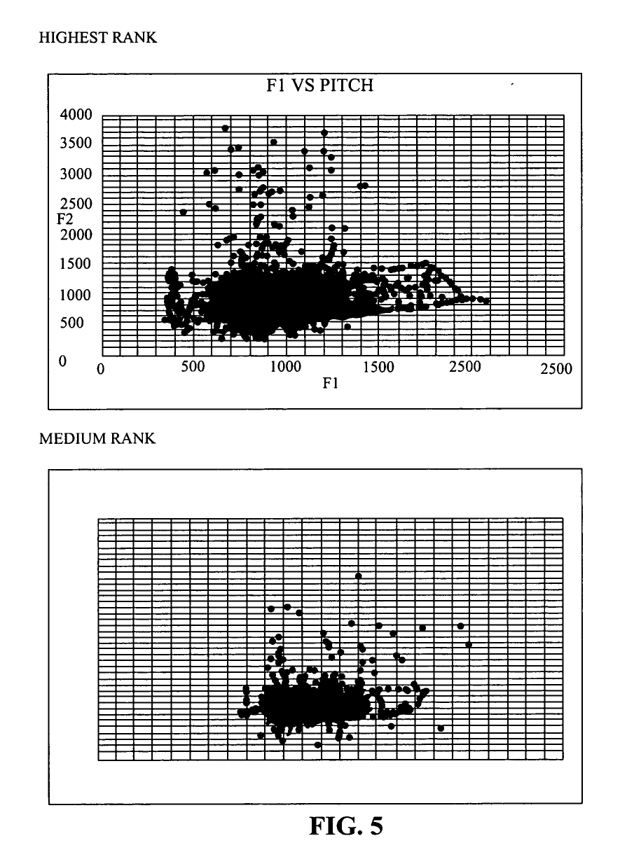

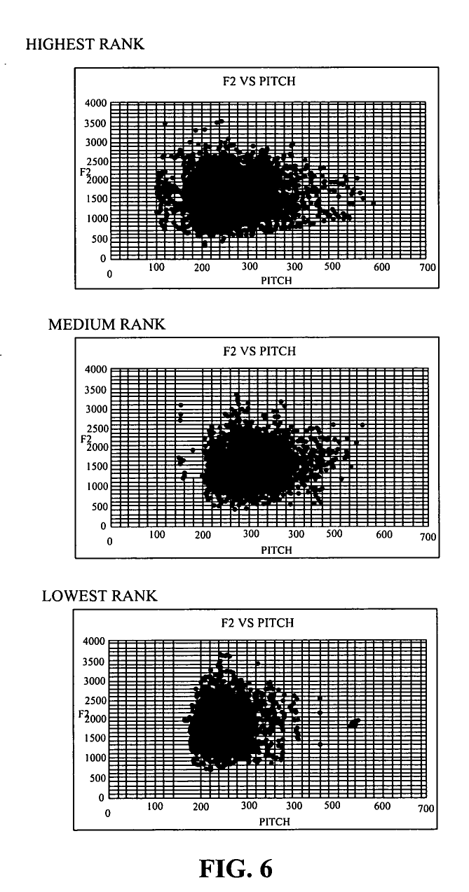

Voice pattern analysis uncovered several parameters linked to speech efficacy. For example, the less effective speakers had stronger correlations between Formant 1 (F1) and Formant 2 (F2), see FIGS. 4, 5, and 6. Formants are the peaks in the frequency spectrum of vowel sounds. There is one formant for each peak. The typical sample of speech is usually considered to have five significant formants. The first three have been shown to have correlations to particular aspects of vowel production in human speech. This correlation means that F2 changes more frequently in the same direction and amount as F1 for less effective speakers than it does for effective speakers. This may indicate that the less effective speakers utilize vowel inflection by using the individual characteristics of inflection together, rather than individually, as more effective speakers do. The manifestation of this effect is seen in FIG. 4, as the less effective speaker's graph has more data points clustered along a diagonal line on the graph running through the origin. The more effective speakers have a higher proportion of data points that lie away from this diagonal line, and seem anti-correlated between F1 and F2. This may indicate more variety in the sound of speech from more effective speakers. The lower scoring speaker's data were also clustered in a narrow range of F1 and F2 frequencies, with fewer data points found in areas of higher frequencies. This may indicate that these speakers utilize a more restricted range of inflection in their vowels, which may be a factor in the listener's perception of monotonous speech.

An example of how this type of data might be implemented in a device is as follows. The system is first be trained to the user's voice to establish an upper and lower limit of vocal frequencies for the two formants. The user then employs the device in an actual speech performance. The device samples an appropriate window of speech, which might be less than one second, or as long as five or ten seconds. The device analyzes that data for Formant 1 and Formant 2 frequencies. As the speaker continues in his or her presentation, the device continues to analyze data within the window, moving that collection window by one window width, or by one or two seconds at a time, whichever is smaller. This provides the user with an output that is essentially indistinguishable from real-time response.

The user output consists of a display of the ratio of the two formants, divided by the ratio of the ranges of the two formants. This results in a ‘percentage of total range’ score. An indicator, such as a bar graph on the device or an associated output device, then represents this score. This bar graph might utilize separate colors, sounds, or other direct feedback for warning the user when moving out of the ideal range in either direction. Another alternative output mode involves continuously updating graph of F2 versus F1. This allows the user to see how he or she was utilizing the formant content in their voice, both in absolute and in relative terms.

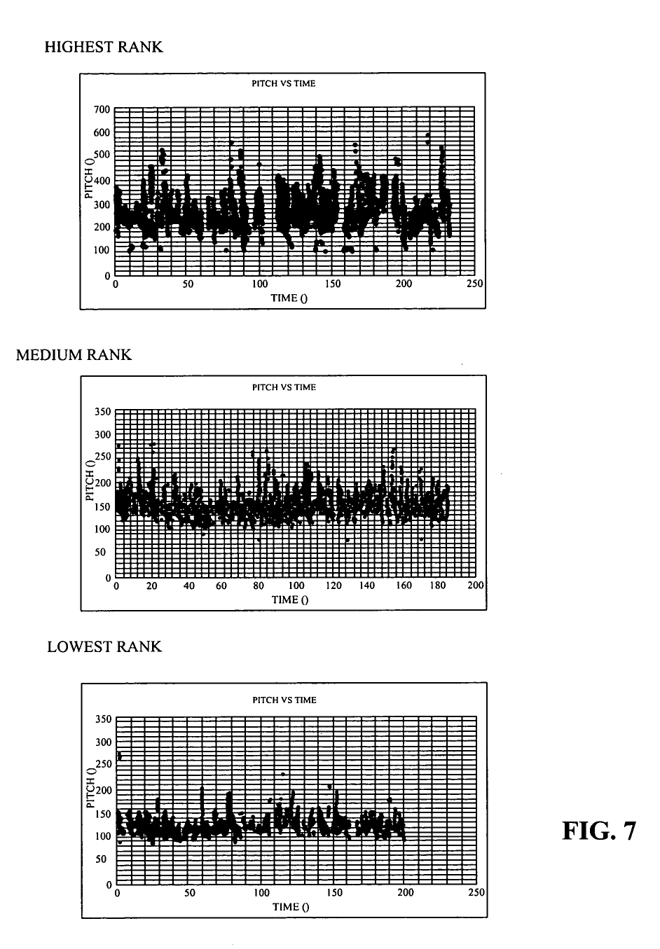

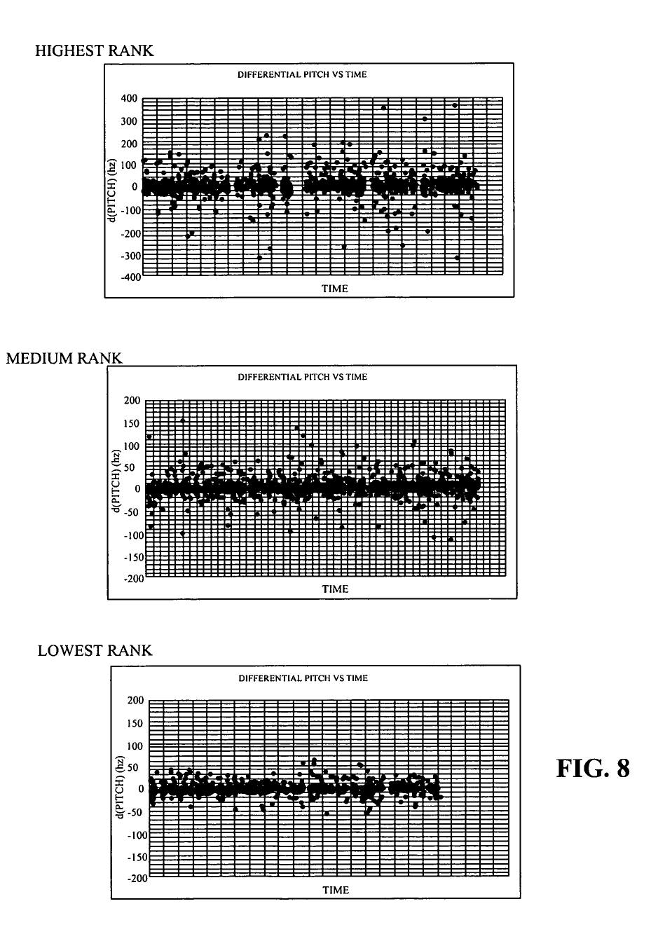

Although the above example delineates the use of one calculated response, other parameters may be measured, and determined alone or simultaneously. For example, in the analysis of the data set described in the previous section, pitch variation (the difference between adjacent pitch samples) and excursion (the range of pitch within the entire analysis window) were parameters that were correlated with efficacy of speech, see FIG. 7. The speakers judged to be most proficient at holding the attention of the listener had the widest range of pitch usage. This data set also evaluated the change in pitch, as measured by the difference between every two adjacent ten millisecond pitch frames. The data from speakers ranked highly in the evaluation exhibited a greater range of the change in pitch than did the data from less effective speakers. These differences were far more apparent when the pitch and pitch change data were smoothed using a standard moving average function, such as the moving average macro program found in Microsoft Excel. Averaging 5 samples, or about 50 milliseconds, resulted in data in which the differential pitch range of the highest-ranking speakers was quite large, the range of a middle-ranking speaker was restricted, and a low-ranking speaker was markedly limited see FIG. 8.

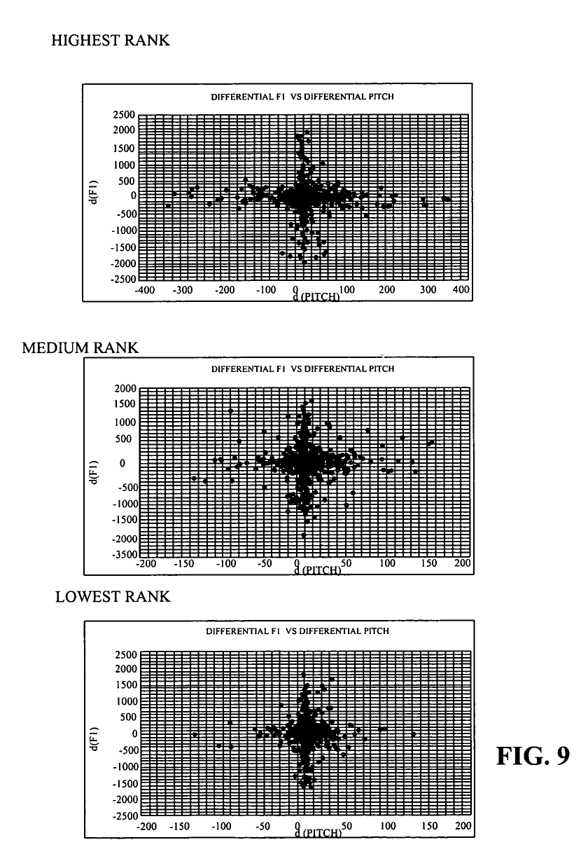

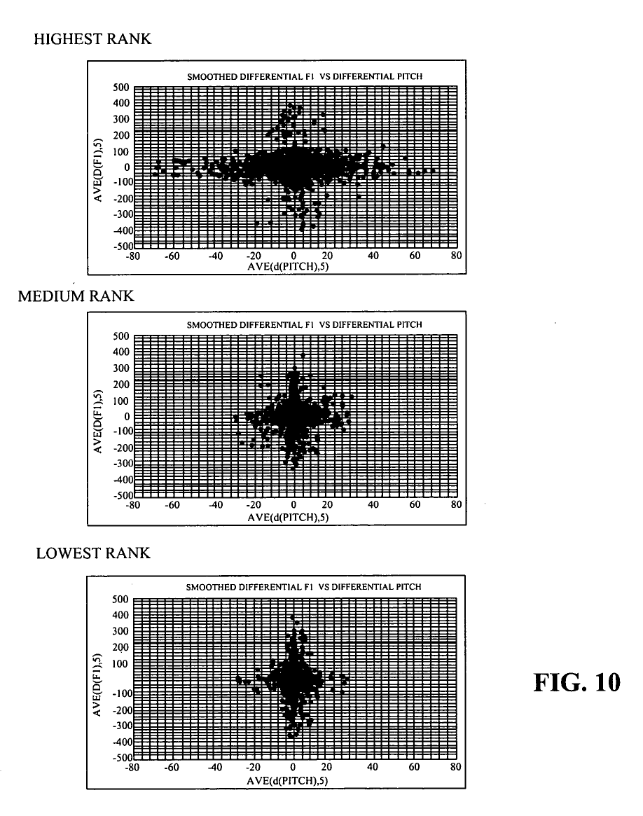

Combining the pitch and pitch change with the Formant 1 data of the speakers provides a correlation between pitch and vowel inflection. This parameter was also significant. Nearly all of the F1 and F2 frequencies were concentrated in a very narrow band of pitch and pitch change frequencies, indicating that vowel inflection was only being employed when the pitch was not changing. The highest rated speakers used vowel inflection while changing pitch to a much larger degree, and much more frequently see FIGS. 9 and 10. This is indicated by spikes in F1 frequencies, both greater in number and at points of greater pitch change. This may translate into perception by the listener of enthusiasm.

Thus, in one data collection window, a single analysis provides the data necessary for a display of the pitch excursion (the total range of pitch used in a specified time) and for a display for the change in pitch (a point-to-point change in pitch, or a pitch slide within-word) of the vocal input. Additionally, the same analysis may provide output with regards to the correlation between vowel inflection and pitch. A moving window of appropriate length is chosen to give a detailed but smoothly changing output, one which appears continuous to the user. The greater the range of the parameter, the larger the response from the device, with the result displayed in appropriate indicators as outlined previously. For example, when considering the pitch excursion and pitch change parameters together, a meter-type display might be best at helping the user find the ‘sweet spot’ with regards to the appropriate degree and frequency of pitch excursion, change, and vowel inflection. Another indicator for pitch range would be a rolling graph of pitch with time, which would provide the user with information about how current delivery compares with speech that was delivered earlier in the presentation.

In the display of the unit, combining the results of the analysis of these four parameters into independent indicators, for example, on the screen of a personal digital assistant (PDA) or hand-held computer (HHC), gives the user a great deal of information with which to assess the progress of his or her speech, and directions in which to modify his or her speech delivery to bring the speech into the norms that they prefer. Alternate and/or additional display or recording devices may also be used.

In summary, the development of analysis algorithms has been exemplified through a discussion of collection of a master data set; the ranking of performances in that data set; the correlation of prosodic parameters against the ranked data; the reduction of that correlative evaluation into a time-varying analytical function; and the transformation of the output of that function into any display that transmits the necessary feedback to the user or record such feedback for later perusal. These examples are not all-inclusive, and any meaningful combination of parameters or means of assessing parameters may be used to provide feedback to the user.

It is further contemplated that non-speech expression of ideal speaker 30 (FIG. 1) such as facial expression, eye movement, eyebrow and brow movement, hand movement or body shift may also be recorded. The data collected may be transformed mathematically using pre-determined algorithm created by assigning a mathematical value to each specific expression according to corresponding desirability. Comprehensive output data associated with the overall expression during a presentation of an ideal speaker may be maintained in an electronic memory that may be accessed optionally from a remote location.

Referring again to FIG. 1, following the step of developing ideal model 11 are the steps of collecting data from test speaker 12, and comparing the data from test speaker 31 to ideal speech model 13. The data associated with verbal or non-verbal expression may be collected from test speaker 31, who may be a student, a trainee, a patient, or any vocal presenter such as a singer or a performer. The collection of data may be accomplished in the same manner as the collection of the data from ideal speaker 30.

This input data is then analyzed in step 16 in the similar manner as the data from ideal speaker 30. The data may be transformed into mathematical values to be compared to corresponding values representing ideal model 11 in step 13. The output data representing deviations from the ideal model indicates the parameters that need improvement.

The output result may be modified into report 33, which may be a graph, a mathematical calculation, or any other verbal report, or non-verbal report. Report 33 may be directly delivered to speaker 31. Alternatively, the output result may be automatically transformed into corresponding feedback instructions 36 as indicated in step 15. Feedback instruction 36 may be subsequently delivered to speaker 31.

Alternatively, the output result may be modified into report 34, which is delivered to instructor 32. Instructor 32 evaluates report 34 and provides feedback instructions 36 to be delivered to speaker 31.

Reports 33, 34 and feedback instructions 36 may be in the forms of verbal or non verbal signs, signals or printouts or text messages.

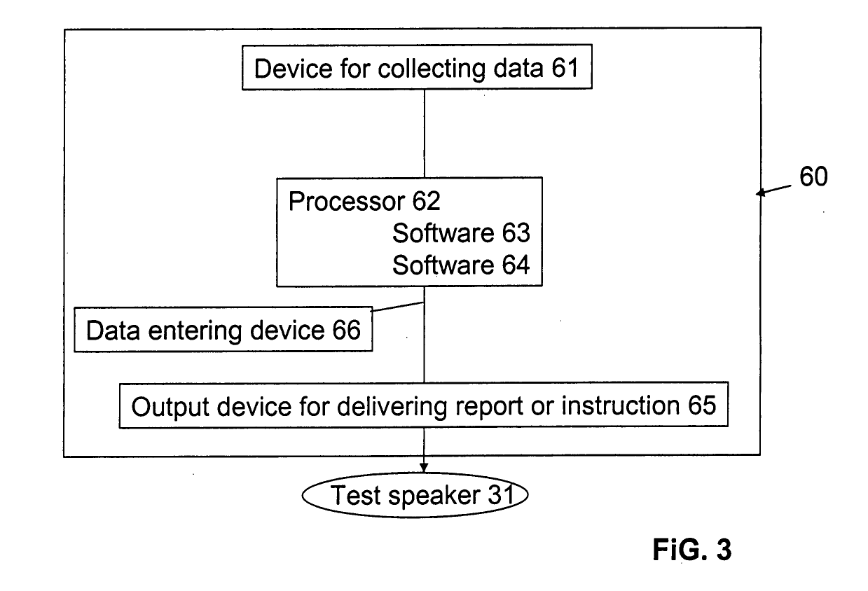

Referring now to FIG. 3, system 60 includes a device for collecting data 61, which may include any suitable recording device such as a voice recorder, a video recorder, or a vibration sensor. Device 61 may be used to collect data from ideal speaker 30, or test speaker 31.

The data collected is transferred to processor 62, which may include a voice analyzer. Processor 62 consists of software 63 for enabling the separation of the input data into measured voice related parameters such as pitch and volume. Processor 62 may also have software 64 for transforming the input data into mathematical formats using pre-determined algorithms. For example, if the pitch value of the ideal model is 5 (representing a medium pitch), and the pitch value of the test speech is 2 (representing a low pitch), the deviation of 3 may indicate that the trainee needs to increase the pitch level by three points or levels in order to improve the trainee's speech to the ideal level. On the other hand, if the test speech shows the pitch value of 8, the trainee should be instructed to lower the pitch when the trainee gives a speech. It is understood that an individual speaker has a limitation in varying the pitch or the volume or other speech characteristics due to the voice related physiology or physical make up. Improvement of an individual speech will take in to account the limitations of individual speakers. For example a test sequence of the vocalization pitch range of each speaker may be recorded and used in the calculations associated with assessment and feedback training for the speaker.

Reports 33, 34 and feedback instructions 36 (in FIG. 1) may be delivered to speaker 31 or instructor 32 through an output device 65 (see FIG. 3). Output device 65 may include an audio device, a visual device or a tactile device. The audio device may be a speaker integrated with a display screen or a one way or a two-way radio connected device. The audio device may also include a sound alarm capable of producing varying sounds corresponding to specific report, or feedback instruction. The visual device may include a display screen capable of displaying a written comprehensive report or graphic report or instructions, or a light box producing varying light signals corresponding to specific report or instruction. The tactile device may be a vibrator capable of producing varying vibration corresponding to specific report or instruction. It is possible that a tactile device may include an electrical or heat device capable of producing a mild electrical stimulation or heat to prompt a speaker to act a certain way. It is also possible to use a combination of devices to report or provide the feedback instruction to the speaker.

Further, it is contemplated that printed output may also be provided for the purpose of keeping permanent records of data output, sets of instructions given and improvement over time.

In one aspect of the present invention, the report delivered to the speaker or the instructor may include a text of the speech, which may be produced using currently available speech recognition software capable of transforming a speech into a written text.

In many cases, it may be necessary to provide feedback instructions to a speaker in real-time during a speech. In this way, the speaker is alerted to the need to alter the speaker's verbal or non verbal expressions. In these particular situations, the feedback may be in a form of a visual signal that may be observed by the speaker such as via a teleprompter or video display.

In another aspect of the present invention, system 60 may include data entering device 66, which may be used by instructor 32 to provide instruction 36 responsive to report 34 to speaker 31. Data entering device may be a keyboard, a voice recorder or any other device capable of receiving data or instruction 36 and transferring instruction 36 to the output device 65.

An illustration of a real-time feed back system of the present invention may be described as follows. In a lecture situation, a small box equipped with a data collecting device such as a microphone and a voice analyzer may be placed on a desk before a speaker. The microphone may be wireless or electronically connected to the voice analyzer. Alternatively, the microphone may be placed on the body of the speaker to pick up the speech of the speaker as it occurs and feed the signal into the voice analyzer. The voice analyzer has software enabling processing and transforming the patterns of sounds into a series of numerical representations using a pre-defined set of mathematical algorithms. The resulting values are fed into a subsequent application that will compare the incoming numeric stream against an ‘ideal’ numeric stream from a pre-programmed database, or against a functional algorithm programmed wit a set of values. Deviations from an ‘ideal’ speech delivery may be indicated immediately to the speaker by either light, sound, vibration, or screen image, and/or may be tabulated for later reference.

Considering an example of electronic components or hardware of a computerized system of the present invention, it is possible to use the components that are currently available, or any suitable improved versions thereof. The system may consist of an input subsystem responsible for the acquisition of analog audio signals (vocal output of the subject under analysis) that will be processed. This subsystem may be connected to a digital signal processor (DSP) that applies predetermined algorithms of a variety and strength to provide useful metric parameters that are indicative of the subjects' performance against a set of training goals. Texas Instruments (TI) is one of several companies making DSP chips that are designed specifically for the processing of analog signals, and which are routinely applied to sophisticated processing of audio signals. In one example, it is possible to use FleXdS TMS320VC5509 DSP module, which consists of a single TI 320VC5509 DSP chip running at 200 MIPS in a module incorporating analog input/output, audio level control, 8 Mbytes of external memory and 1 Mbyte of non-volatile flash memory. The output of the module may be routed to an onboard USB port for connection to a variety of computer resources, or to a series of eight programmable LED indicators. The device is small, lightweight, and backed up by battery to maintain programming in the event of power disconnection.

An audio input may be supplied to the DSP chip through the board level interface, and auditory feedback to the user may be supplied by the audio output section of the module. The algorithms for processing the speech signals may be stored in the non-volatile memory on the module, or on the user interface device. The actual algorithms would be determined according to the needs of the training. These would include, but not be limited to, pitch and intonation extraction, rate of change of pitch, intensity, periodic and acyclic features, formant analyses, and cadence analysis. Programming that implements the algorithms may be created using any of a number of standard development environments for DSP systems, including Code Composer, a suite of development product designed specifically for the TI DSP product families. Algorithm implementations for these parameter extractions exist in the literature, and optimization for the DSP environment may follow standard programming schemas. The module may interface with the user interface subsystem through the USB.

The user interface subsystem has several aspects to be sufficiently useful to the subject, with the flexibility to provide an adjustable and reconfigurable set of feedback indicators. These aspects are almost ideally fulfilled by the current set of personal digital assistants available from a variety of sources. In particular, the Windows CE compatible devices are well suited to this task. These devices have robust and powerful development environments, the processor power and memory capacity to house not only the feedback elements, but also provide logging and data analysis capability to help the user and any trainers assess progressive improvement in performance. The screens are capable of highly visible, vivid colors with sufficient resolution and size to enable the system to provide configurations of wide variety to suit the context of the learning environment. In its simplest forms, the display may simultaneously show a running histogram of the frequency of pitch band utilization, a streaming strip of formant vs. time plots, and a multi-color bar graph of the rate of pitch change. With minimal changes to the screen design, most likely user selectable changes, the system may be reconfigured to provide a single multicolored indicator providing a sort of “grand average” indication of goal achievement for use in public speaking conditions, where detailed displays may be too distracting to be effective.

The supporting circuitry may be minimal in this example. Suitable power, input/output connections and connectors to the PDA would be required. The most probable use for the LED connections on the DSP module would be as audio level indicators to maximize the signal processing capabilities of the system.

While this invention has been described as having exemplary formulations, the invention may be further modified within the spirit and scope of this disclosure. This ion is therefore intended to cover any variations, uses, or adaptations of the invention general principles. Further, this application is intended to cover such departures from ent disclosure as come within known or customary practice in the art to which this n pertains and which fall within the limits of the appended claims.

1. A method for providing feedback speech instructions comprising the steps of:
(a) collecting data corresponding to a plurality of parameters associated with expressions of a speaker;
(b) determining deviations of the collected data from an ideal model; and
(c) instructing the speaker responsive to the deviations.

2. The method of claim 1 further comprising the step of:
(d) developing a database of an ideal speech model prior to step (a).

3. The method of claim 2, wherein step (d) comprises the steps of:
(e) collecting ideal speech data corresponding to a plurality of parameters associated with expressions of at least one ideal speaker;
(f) determining the ideal speech model from the collected ideal speech data by applying at least one pre-determined algorithm; and
(g) storing the processed ideal speech data in a database as the database of an ideal model.

4. The method of claim 3, wherein step (a) comprises the steps of:
(h) determining the speech data of the speaker from the collected data by applying at least one pre-determined algorithm; and
(i) comparing the speaker's speech data with the processed ideal speech data.

5. The method of claim 1 further comprising the step of:
(j) generating a report based on a result of step (b).

6. The method of claim 5, wherein step (j) includes generating an instruction responsive to the result of step (b).

7. The method of claim 6, wherein the instruction includes at least one of: a verbal instruction, a non-verbal instruction, a perceptible signal and a combination thereof.

8. The method of claim 7, wherein the perceptible signal includes at least one of: an audio signal, a visual signal, a sign, a tactile signal, and a combination thereof.

9. The method of claim 5 further comprising the step of:
(k) delivering the report to at least one recipient.

10. The method of claim 9 further comprising the steps of:
(l) generating an instruction based on the report; and
(m) delivering the instruction to the speaker.

11. The method of claim 10, wherein the step of (m) includes at least one of: displaying the instruction on a display screen, sending an instruction through an audio device, sending an instruction through a visual device, sending an instructional signal through a tactile device, and a combination thereof.

12. The method of claim 1, wherein the plurality of parameters in the step (a) comprises at least one of: pitch, volume, pitch variation, volume variation, frequency of variation of pitch, frequency of volume, rhythm, tone, speech cadence, and a combination thereof.

13. A method for developing a database of an ideal speech model comprising the steps of:
(a) collecting ideal speech data corresponding a plurality of parameters associated with expressions of at least one ideal speaker; wherein the plurality of parameters comprises at least one of: pitch, volume, pitch variation, volume variation, frequency of variation of pitch, frequency of volume, rhythm, tone, speech cadence and a combination thereof; and
(b) determining an ideal speech model from the collected ideal speech data by applying at least one pre-determined algorithm.

14. The method of claim 13 further comprising the step of:
(c) storing the processed ideal speech data corresponding to the ideal speech model in a retrievable database.

15. The method of claim 13 further comprising the steps of:
(d) collecting speech data from a speaker;
(e) analyzing the speech data from the speaker based on the processed ideal speech data;
(f) generating a report based on the analyzed speech data; and
(g) delivering the report to at least one recipient.

16. The method of claim 15, wherein step (e) includes analyzing the speech data in real time.

17. The method of claim 15, wherein step (e) includes analyzing the speech data in a subsequent review.

18. The method of claim 15, wherein step (g) includes delivering the analyzed data in the report.

19. The method of claim 15, wherein step (g) includes delivering a corresponding instruction.

20. A system for providing a feedback speech instruction comprising the steps of:
a device for collecting data corresponding to a plurality of parameters associated with expressions of a speaker;
a module connected to said device for collecting and processing data; said module having software or firmware for enabling analysis of collected data based on an ideal speech model and generating a report based on the analysis; and
an output device for delivering the report to at least one recipient.

21. The system of claim 20, wherein said device for collecting data comprises at least one of:
a recorder, a sensor, a video camera, a data entry device and a combination thereof.

22. The system of claim 20, wherein the output device includes at least one of: an audio device, a visual device, a tactile device and a combination thereof.

23. The system of claim 20, wherein the report includes a corresponding instruction.

24. The system of claim 20 further comprising:
a data entry device for entering an instruction responsive to the report; and
an instruction delivery device for delivering the instruction to the speaker.

25. The system of claim 24, wherein the instruction delivery device includes at least one of:
an audio device, a visual device, a tactile device and a combination thereof.
